(19) United States
(12) Patent Application Publication
(10) Pub. No.: US 2016/0335430 A1
(43) Pub. Date: Nov. 17, 2016

(54) Apparatus and Method for Detecting Buffer Overflow Attack, and Security Protection System

(71) Applicant: Huawei Technologies Co., Ltd., Shenzhen (CN)

(72) Inventors: Hongbin Zhou, Shenzhen (CN); Xiang Zhang, Shenzhen (CN)

(21) Appl. No.: 15/218,985

(22) Filed: Jul. 25, 2016

Related U.S. Application Data
(63) Continuation of application No. PCT/CN2014/094492, filed on Dec. 22, 2014.

(30) Foreign Application Priority Data
Jan. 26, 2014 (CN) 201410038712.2

(51) Int. Cl. G06F 21/52

(52) U.S. Cl. CPC G06F 21/52

(57) ABSTRACT

An apparatus and a method for detecting a buffer overflow attack, and a security protection system. The apparatus for detecting a buffer overflow attack includes a memory storing instructions, a processor configured to execute the instructions stored in the memory to obtain external input data for a target process, determine that the target process decodes the external input data, detect attack code on the decoded external input data, wherein the attack code is a code used for performing an overflow attack on a buffer, where the apparatus or the method facilitates detection of attack code from the data obtained by decoding, and may improve a detection rate of the attack code.

### CROSS-REFERENCE TO RELATED APPLICATIONS

This application is a continuation of International Application No. PCT/CN2014/094492, filed on Dec. 22, 2014, which claims priority to Chinese Patent Application No. 201410038712.2, filed on Jan. 26, 2014, both of which are hereby incorporated by reference in their entireties.

### TECHNICAL FIELD

The present disclosure relates to the field of system security detection, and in particular, to an apparatus and a method for detecting a buffer overflow attack, and a security protection system.

### BACKGROUND

Buffer overflow is a very common and very risky vulnerability, and widely exists in various operating systems and application software. Exploitation of a buffer overflow attack may cause consequences such as program running failure, system breakdown, or system restart. More severely, a buffer overflow attack may be exploited for executing an unauthorized instruction, or even a system privilege may be obtained, and then various illegal operations are performed.

To detect a buffer overflow attack, a conventional detection method is, full-address space scanning is performed on a target process, and whether attack code (e.g. SHELLCODE) used for implementing buffer overflow exists in the target process is analyzed. For example, SHELLCODE monitoring is performed based on memory search, and SHELLCODE encoded, encrypted and hidden in a complex application document format can be detected. However, normal executable code and SHELLCODE exist in memory of a process at the same time, and the two pieces of code are similar, and are identified with difficulty. What is worse, when the memory of the process is scanned, malicious code may not be decoded, and SHELLCODE cannot be detected, and therefore a missing report rate is high.

Another conventional detection method is, data (such as a file or a network data packet) input into a target program is analyzed, the input data (such as a portable document format (PDF) file, a document (DOC) file, or a network data packet) is parsed, and whether SHELLCODE exists in the input data is identified. For example, current mainstream antivirus software may directly parse a file in a format such as PDF, and then rule matching is directly performed on the parsing result in order to determine whether SHELLCODE exists in a target file, some antivirus software implements some functions of a script engine by itself, and after a script in a PDF file is obtained by parsing, the script is executed, and then rule matching is performed in order to determine whether SHELLCODE exists in a target file. However, according to this method, in-depth analysis of a format of a file or network data packet is required, which is greatly difficult for an undisclosed file format and an undisclosed network data packet format. What is worse, SHELLCODE in original input data may be processed using a hidden technology such as encryption or encoding, and original SHELLCODE is restored only during a running process. Moreover, SHELLCODE may exist in a non-script area, and detection cannot be implemented if a script area is analyzed only.

To sum up, the conventional methods for detecting a buffer overflow attack is great in detection difficulty, and high in missing detection rate.

### SUMMARY

### Technical problem

In view of this, a technical problem to be resolved by the present disclosure is how to reduce a difficulty in detecting a buffer overflow attack, and improve a detection rate of attack code.

### Solution

To resolve the foregoing technical problem, according to a first aspect, an apparatus for detecting a buffer overflow attack is provided, including a target process configured to obtain external input data, and an attack-code detection module configured to perform attack-code detection, where attack code is code used for performing an overflow attack on a buffer, where the target process is further configured to invoke the attack-code detection module to start performing the attack-code detection on data obtained by decoding when processing the external input data, and if it is monitored that the target process performs decoding on the external input data.

With reference to the first aspect, in a first possible implementation manner of the first aspect, the apparatus further includes a detection scheduling module configured to start the target process, and a hooking module configured to hook the attack-code detection module to a key data processing point of the target process, where the key data processing point is a memory allocation action and/or memory access action needed for performing script decoding on the external input data, where the detection scheduling module is further configured to control the target process to load the hooking module, and the target process is further configured to invoke the attack-code detection module to start performing the attack-code detection, after loading the hooking module, and when the key data processing point is detected.

With reference to the first aspect or the first possible implementation manner of the first aspect, in a second possible implementation manner of the first aspect, the target process is further configured to invoke the attack-code detection module to perform, according to a rule for the attack code after decoding, matching on the data obtained by decoding, and determine whether the attack code exists in the data obtained by decoding.

With reference to the first aspect or the first possible implementation manner of the first aspect or the second possible implementation manner of the first aspect, in a third possible implementation manner of the first aspect, the attack-code detection module is further configured to output a detection log according to a result of the attack-code detection after starting performing the attack-code detection on the data obtained by decoding.

According to a second aspect, a security protection system is provided, including the apparatus for detecting a buffer overflow attack provided in the foregoing first aspect, or any possible implementation manner of the first aspect, and a network security apparatus configured to restore obtained network traffic to the external input data, send the external input data to the apparatus for detecting a buffer overflow attack, receive a detection result fed back by the apparatus for detecting a buffer overflow attack, and adjust a control policy according to the detection result.

According to a third aspect, a security protection system is provided, including the apparatus for detecting a buffer overflow attack provided in the foregoing first aspect, or any possible implementation manner of the first aspect, and an application server configured to send a submitted file used as external input data to the apparatus for detecting a buffer overflow attack, receive a detection result fed back by the apparatus for detecting a buffer overflow attack, and adjust a control policy according to the detection result.

According to a fourth aspect, a method for detecting a buffer overflow attack is provided, including obtaining, by a target process, external input data, and when the target process processes the external input data, if it is monitored that the target process performs decoding on the external input data, starting performing attack-code detection on data obtained by decoding, where attack code is code used for performing an overflow attack on a buffer.

With reference to the fourth aspect, in a first possible implementation manner of the fourth aspect, before obtaining, by a target process, external input data, the method includes starting the target process, and hooking the action of starting performing the attack-code detection to a key data processing point of the target process such that the target process after hooking can start performing the attack-code detection when the key data processing point is detected, where the key data processing point is a memory allocation action and/or memory access action needed for performing script decoding on the external input data.

With reference to the fourth aspect or the first possible implementation manner of the fourth aspect, in a second possible implementation manner of the fourth aspect, starting performing attack-code detection on data obtained by decoding includes performing, according to a rule for the attack code after decoding, matching on the data obtained by decoding, and determining whether the attack code exists in the data obtained by decoding.

With reference to the fourth aspect or the first possible implementation manner of the fourth aspect or the second possible implementation manner of the fourth aspect, in a third possible implementation manner of the fourth aspect, after starting performing attack-code detection on data obtained by decoding, the method includes outputting a detection log according to a result of the attack-code detection.

### Beneficial Effects

In embodiments of the present disclosure, when processing external input data, a target process may invoke, if it is monitored that the target process performs decoding on the external input data, an attack-code detection module to start performing attack-code detection on data obtained by decoding, which facilitates detection of attack code from the data obtained by decoding, and can improve a detection rate of the attack code.

By describing in detail exemplary embodiments according to the following reference accompanying drawings, other characteristics and aspects of the present disclosure become clear.

### BRIEF DESCRIPTION OF DRAWINGS

The accompanying drawings that are included in the specification and constitute a part of the specification show exemplary embodiments, characteristics, and aspects of the present disclosure together with the specification, and are used to explain the principle of the present disclosure.

FIG. 1 is a schematic diagram of an apparatus for detecting a buffer overflow attack according to Embodiment 1 of the present disclosure;

FIG. 2 is a schematic diagram of an apparatus for detecting a buffer overflow attack according to Embodiment 2 of the present disclosure;

FIG. 3 is a schematic diagram of a security protection system according to Embodiment 3 of the present disclosure;

FIG. 4 is a schematic diagram of a security protection system according to Embodiment 4 of the present disclosure;

FIG. 5 is a flowchart diagram of a method for detecting a buffer overflow attack according to Embodiment 5 of the present disclosure;

FIG. 6 is a flowchart diagram of a method for detecting a buffer overflow attack according to Embodiment 6 of the present disclosure;

FIG. 7 is a flowchart diagram of a method for detecting a buffer overflow attack according to Embodiment 7 of the present disclosure;

FIG. 8 is a flowchart diagram of a method for detecting a buffer overflow attack according to Embodiment 8 of the present disclosure; and

FIG. 9 is a schematic diagram of an apparatus for detecting a buffer overflow attack according to Embodiment 9 of the present disclosure.

### DESCRIPTION OF EMBODIMENTS

The following describes various exemplary embodiments, features, and aspects of the present disclosure in detail with reference accompanying drawings. Same reference numerals in the accompanying drawings designate elements that have same or similar functions. Various aspects of the embodiments illustrated in the accompanying drawings may not be necessarily drawn to scale, unless otherwise specified.

The term “exemplary” means being used as an example or an embodiment, or serving an illustrative purpose. Any “exemplary” embodiment described herein shall not be construed as being superior to or better than other embodiments.

Furthermore, to better describe the present disclosure, many details are provided in the following specific implementation manners. A person skilled in the art should understand that, the present disclosure may also be implemented without these details. In some examples, the method, approach, component, and circuit that are known to a person skilled in the art are not described in detail in order to focus on the purport of the present disclosure.

### Embodiment 1

Currently, targets on which a buffer overflow attack is performed using attack code (e.g. SHELLCODE) may mainly include a browser, a PDF reader, MICROSOFT OFFICE software and the like. SHELLCODE generally exists in a target file such as a webpage, a PDF file, or a MICROSOFT OFFICE document in a form of encrypted data or encoded data, and SHELLCODE not only may exist in a script area of the target file, but may also exist in another object of the target file, such as a data area. SHELLCODE in a final form is released only during script running, and then an attack is implemented using a vulnerability. Therefore, if a final release link of SHELLCODE is determined, and SHELLCODE is monitored and detected in the final release link of SHELLCODE, effectiveness and accuracy of identifying SHELLCODE can be greatly improved.

In this embodiment of the present disclosure, a key processing point of SHELLCODE converted from an encoded state or encrypted state into a final state is monitored, enhancing detection pertinence and improving a detection rate of SHELLCODE. The key data processing point refers to an action of decrypting or decoding data in an encoded state or encrypted state, and the action may be a function, or may be a machine instruction.

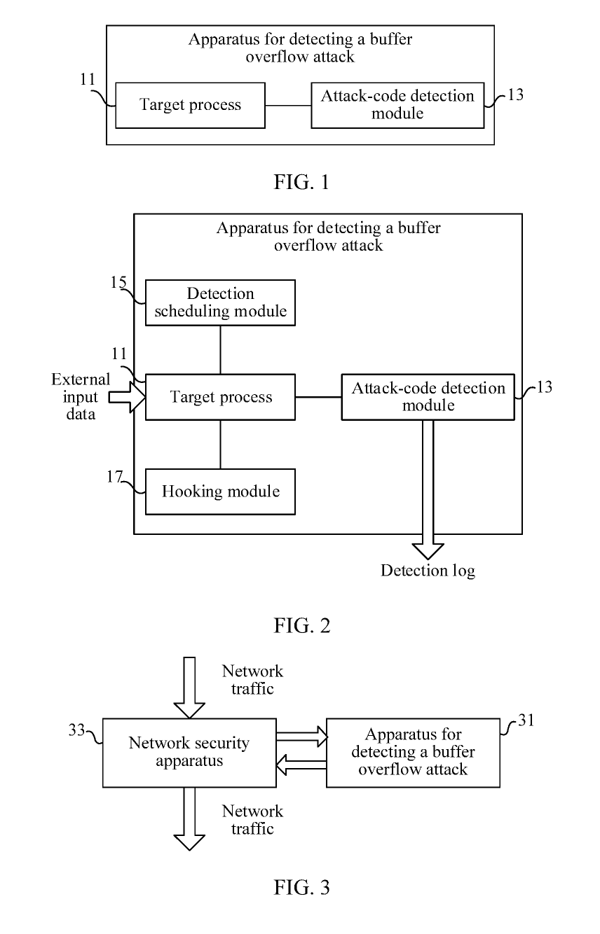

FIG. 1 is a schematic diagram of an apparatus for detecting a buffer overflow attack according to Embodiment 1 of the present disclosure. As shown in FIG. 1, the apparatus for detecting a buffer overflow attack may include a target process 11 configured to obtain external input data, and an attack-code detection module 13 configured to perform attack-code detection, where the attack code is the code used for performing an overflow attack on a buffer. The target process 11 is further configured to invoke the attack-code detection module 13 to start performing the attack-code detection on data obtained by decoding when processing the external input data, and if it is monitored that the target process 11 performs decoding on the external input data.

Furthermore, in this embodiment of the present disclosure, the target process 11 may be a process generated by running multiple application programs, for example a process generated by running an application program such as an open-source browser WEBKIT, an INTERNET EXPLORER browser, an Adobe Reader, or a MICROSOFT OFFICE. In this embodiment of the present disclosure, an example in which the target process 11 is an open-source browser WEBKIT is used for description, which is likewise applicable to another target process. In this embodiment of the present disclosure, the external input data refers to data in a predetermined format that the target process can process. For example, external input data of a WEBKIT or an INTERNET EXPLORER browser may be a hypertext markup language (HTML) webpage, a JAVASCRIPT script or the like, external input data of an Adobe Reader may be a PDF file or the like, external input data of a MICROSOFT OFFICE may be a word file, an excel file or the like.

For example, in a WEBKIT, all new character strings generated by running a script or memory allocated by running a script is an instance generated by a script character string (JSString) object. However, script decoding and releasing SHELLCODE in a final form are generally converted into processing on the JSString object, and therefore an action of creating and accessing the JSString object may be monitored, and when the JSString object is created or the JSString object is accessed, the target process 11 may invoke the attack-code detection module 13 to implement detection on SHELLCODE.

According to the apparatus for detecting a buffer overflow attack of this embodiment, when processing external input data, a target process 11 may invoke, if it is monitored that a target process 11 performs decoding on the external input data, an attack-code detection module 13 to start performing attack-code detection on data obtained by decoding, which facilitates detection of attack code from the data obtained by decoding, and improves a detection rate of the attack code.

### Embodiment 2

FIG. 2 is a schematic diagram of an apparatus for detecting a buffer overflow attack according to Embodiment 2 of the present disclosure. Components in FIG. 2 that have same reference numerals as those of components in FIG. 1 have same functions as those of the components in FIG. 1, and for the purpose of conciseness, detailed description of these components is omitted. As shown in FIG. 2, a main difference between this embodiment and the foregoing embodiment lies in that, the apparatus for detecting a buffer overflow attack may further include a detection scheduling module 15 configured to start the target process 11, and a hooking module 17 configured to hook the attack-code detection module 13 to a key data processing point of the target process 11, where the key data processing point is a memory allocation action and/or memory access action needed for performing script decoding on the external input data, where the hooking refers to implementing a monitoring action on the key data processing point using program code. The detection scheduling module 15 is further configured to control the target process 11 to load the hooking module 17. The target process 11, after loading the hooking module 17, is further configured to invoke the attack-code detection module 13 to start performing the attack-code detection when the key data processing point is detected. That the target process 11 loads the hooking module 17 refers to that program code in the hooking module 17 is loaded to the target process 11 for execution such that the target process 11 monitors the key data processing point.

Furthermore, using an open-source browser WEBKIT as an example, creating and/or accessing a JSString object may be used as the key data processing point, where creating a JSString object involves a memory allocation action, accessing a JSString object involves a memory access action. During creation of the JSString object, the target process 11 needs to apply to a detection system for memory allocation, and during access to the JSString object, the target process 11 needs to access memory. Therefore, the hooking module 17 may modify an action of creating and/or accessing the JSString object, and add code for monitoring the key data processing point. The detection scheduling module 15 loads the hooking module 17, a monitoring action may be added to during creation of and/or access to the JSString object in the WEBKIT, and the WEBKIT is instructed, when the action of creating and/or accessing the JSString object is performed, to invoke the attack-code detection module 13 to start performing the attack-code detection. The WEBKIT runs a script of the external input data, such as, an HTML file, a JAVASCRIPT file, or a network data packet. During running of the script, the external input data is decoded, and if the WEBKIT performs the action of creating and/or accessing the JSString object, the attack-code detection module may be invoked to start performing detection on attack code of buffer overflow.

Besides the WEBKIT, other application programs may also correspondingly determine respective key data processing points.

For example, a PDF reader such as Adobe Reader also processes a script using a script engine EScript.api, and therefore as long as key data processing points for character string allocation and character string access in EScript.api are monitored, whether the PDF includes buffer overflow attack data may be detected.

For another example, an INTERNET EXPLORER browser is also similar to the open-source browser, where by monitoring creation of and access to the JSString object in a JAVASCRIPT engine JSCRIPT.DLL, and by monitoring creation of and access to a VbsString object in a VBScript engine VBScript.dll, whether a webpage file includes buffer overflow attack data may be detected in the INTERNET EXPLORER.

In a possible implementation manner, the target process 11 is further configured to invoke the attack-code detection module 13 to perform, according to a rule for the attack code after decoding, matching on the data obtained by decoding, and determine whether the attack code exists in the data obtained by decoding. A matching rule used in a detection process may be the rule for the attack code after decoding. Because a quantity of rules for SHELLCODE after decoding is relatively small, needed matching rules are also relatively small in quantity, generally being several thousands, the detection process is relatively fast, and a missing detection rate is low.

In a possible implementation manner, the attack-code detection module 13 is further configured to output a detection log according to a result of the attack-code detection after starting performing the attack-code detection on the data obtained by decoding.

According to the apparatus for detecting a buffer overflow attack of this embodiment, a detection scheduling module 15 controls a target process 11 to load a hooking module 17, and when a key data processing point is detected, the target process 11 is hooked to invocation on an attack-code detection module 13 to start performing attack-code detection such that when processing external input data, the target process 11 may invoke, if it is monitored that the target process 11 performs decoding on the external input data, the attack-code detection module 13 to start performing attack-code detection on data obtained by decoding, which facilitates detection of attack code from the data obtained by decoding, and can improve a detection rate of the attack code.

### Embodiment 3

FIG. 3 is a schematic diagram of a security protection system according to Embodiment 3 of the present disclosure. As shown in FIG. 3, the security protection system may include an apparatus for detecting a buffer overflow attack 31 in any structure in the foregoing embodiments of the present disclosure, and a network security apparatus 33 configured to restore obtained network traffic to the external input data, such as an HTML webpage or a JAVASCRIPT script, send the external input data to the apparatus for detecting a buffer overflow attack 31, receive a detection result fed back by the apparatus for detecting a buffer overflow attack 31, and adjust a control policy according to the detection result.

Furthermore, the apparatus for detecting a buffer overflow attack 31 of this embodiment of the present disclosure may be used in combination with various security products, for example, used in combination with a network security apparatus 33 of a security gateway type such as a firewall, or a network security apparatus 33 of a terminal security type such as antivirus software. Using a firewall as an example, the apparatus for detecting a buffer overflow attack 31 of this embodiment of the present disclosure may work in coordination with the firewall, or may be integrated inside the firewall, to provide a SHELLCODE detection capability.

According to the security protection system of this embodiment, an apparatus for detecting a buffer overflow attack 31 may be combined with a network security apparatus 33, and attack-code detection is started when script decoding is performed on external input data, which facilitates detection of attack code from data obtained by decoding, and may improve a detection rate of the attack code.

### Embodiment 4

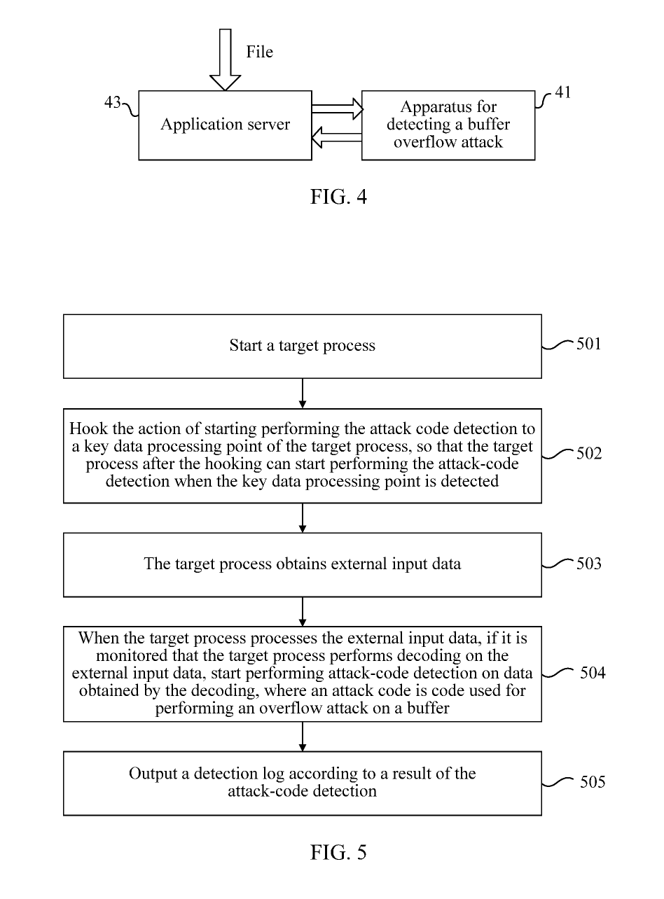

FIG. 4 is a schematic diagram of a security protection system according to Embodiment 4 of the present disclosure. As shown in FIG. 4, the security protection system may include an apparatus for detecting a buffer overflow attack 41 in any structure in the foregoing embodiments of the present disclosure, and an application server 43 configured to send a submitted file used as external input data to the apparatus for detecting a buffer overflow attack 41, receive a detection result fed back by the apparatus for detecting a buffer overflow attack 41, and adjust a control policy according to the detection result.

Furthermore, the present disclosure may be applied to a product of a file-related application server type, such as a mail server or a file server. In this embodiment of the present disclosure, the apparatus for detecting a buffer overflow attack 41 may work in coordination with a file-related application server such as a file server or a mail server, to provide a SHELLCODE detection capability. A file may be submitted to the security protection system by a user, a server or a client.

According to the security protection system of this embodiment, an apparatus for detecting a buffer overflow attack 41 may be combined with an application server 43, and attack-code detection is started when script decoding is performed on external input data, which facilitates detection of attack code from data obtained by decoding, and may improve a detection rate of the attack code.

### Embodiment 5

FIG. 5 is a flowchart diagram of a method for detecting a buffer overflow attack according to Embodiment 5 of the present disclosure. As shown in FIG. 5, the method for detecting a buffer overflow attack may include the following steps.

Step 503: A target process obtains external input data.

Step 504: When the target process processes the external input data, if it is monitored that the target process performs decoding on the external input data, start performing attack-code detection on data obtained by decoding, where the attack code is the code used for performing an overflow attack on a buffer.

In a possible implementation manner, before step 503, the method for detecting a buffer overflow attack may further include the following steps.

Step 501: Start the target process.

Step 502: Hook the action of starting performing the attack-code detection to a key data processing point of the target process such that the target process after the hooking may start performing the attack-code detection when the key data processing point is detected, where the key data processing point is a memory allocation action and/or memory access action needed for performing script decoding on the external input data.

In a possible implementation manner, starting performing the attack-code detection on the data obtained by decoding may further include performing, according to a rule for attack code after decoding, matching on the data obtained by decoding, and determining whether the attack code exists in the data obtained by decoding.

In a possible implementation manner, after starting performing the attack-code detection on the data obtained by decoding, the method further includes the following step.

Step 505: Output a detection log according to a result of the attack-code detection.

According to the method for detecting a buffer overflow attack of this embodiment, if it is monitored that a target process performs decoding on external input data, attack-code detection may be started on data obtained by decoding, which facilitates detection of attack code from the data obtained by decoding, and may improve a detection rate of the attack code.

### Embodiment 6

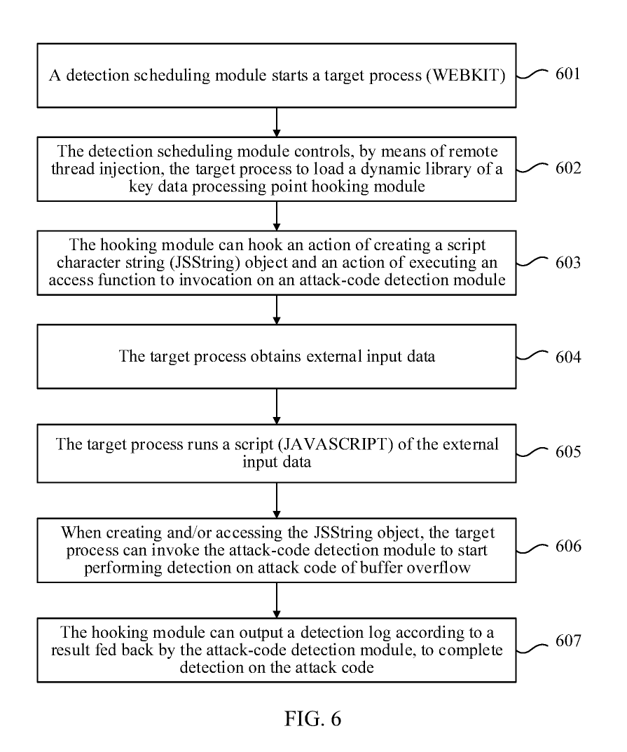

FIG. 6 is a flowchart diagram of a method for detecting a buffer overflow attack according to Embodiment 6 of the present disclosure. As shown in FIG. 6, an example in which a target process is a WEBKIT is used, and the method for detecting a buffer overflow attack is performed using the apparatus for detecting a buffer overflow attack of the foregoing embodiment of the present disclosure, and may include the following steps.

Step 601: A detection scheduling module starts a target process; the target process in the present embodiment is WEBKIT.

Step 602: The detection scheduling module controls, by means of remote thread injection, the target process to load a dynamic library of a key data processing point hooking module. The remote thread injection refers to creating a remote thread in a process (invoker) using an invoking interface provided by an operating system in order to enter memory address space of the target process such that the target process executes executable code (remote thread) given by the invoker. In this embodiment of the present disclosure, the detection scheduling module may create a section of code, and write the code into the memory address space of the target process in order to control the target process to load the dynamic library, of the key data processing point, stored in the hooking module.

For example, in the WEBKIT, creation of and access to a JSString object may be used as the key data processing point. During the creation of the JSString object, the target process needs to apply to the operating system for memory allocation, and during execution of an access function, the target process needs to access memory.

Besides the WEBKIT, other application programs may also correspondingly determine respective key data processing points.

For example, a PDF reader such as Adobe Reader also processes a script using a script engine EScript.api, and therefore as long as key data processing points for character string allocation and character string access in EScript.api are monitored, whether the PDF includes buffer overflow attack data may be detected.

For another example, an INTERNET EXPLORER browser is also similar to the open-source browser where by monitoring creation of and access to the JSString object in a JAVASCRIPT engine JSCRIPT.DLL, and by monitoring creation of and access to a VbsString object in a VBScript engine VBScript.dll, whether a webpage file includes buffer overflow attack data may be detected in the INTERNET EXPLORER.

Step 603: The hooking module can hook an action of creating a JSString object and an action of executing an access function to invocation on an attack-code detection module such that the target process invokes, when a function of creating the JSString object and/or of accessing the JSString object is executed, the attack-code detection module to start performing attack-code detection.

Step 604: The target process obtains external input data, such as an HTML file, a JAVASCRIPT file or a network data packet.

Step 605: The target process runs a script, for example JAVASCRIPT, of the external input data.

Step 606: When the target process creates and/or accesses the JSString object, perform decoding on the external input data during running of the script, where SHELLCODE may be released after decoding, and therefore, when creating and/or accessing the JSString object, the target process can invoke the attack-code detection module to start performing detection on attack code of buffer overflow. A matching rule used in a detection process may be a rule for the attack code after decoding. Because a quantity of rules for SHELLCODE after decoding is relatively small, needed matching rules are also relatively small in quantity, generally being several thousands, the detection process is relatively fast, and a missing detection rate is low.

Step 607: The hooking module can output a detection log according to a result fed back by the attack-code detection module, to complete detection on the attack code (e.g. SHELLCODE).

According to the method for detecting a buffer overflow attack of this embodiment, a detection scheduling module controls a target process to load a hooking module, and a key data processing point, that is, an action of creating and/or accessing an JSString object, of the target process may be hooked to invocation on an attack-code detection module to start performing attack-code detection such that when processing external input data, the target process may invoke, if it is monitored that the target process performs decoding on the external input data, that is, the action of creating and/or accessing the JSString object occurs, the attack-code detection module to start performing the attack-code detection on data obtained by decoding, which facilitates detection of attack code from the data obtained by decoding, and can improve a detection rate of the attack code.

### Embodiment 7

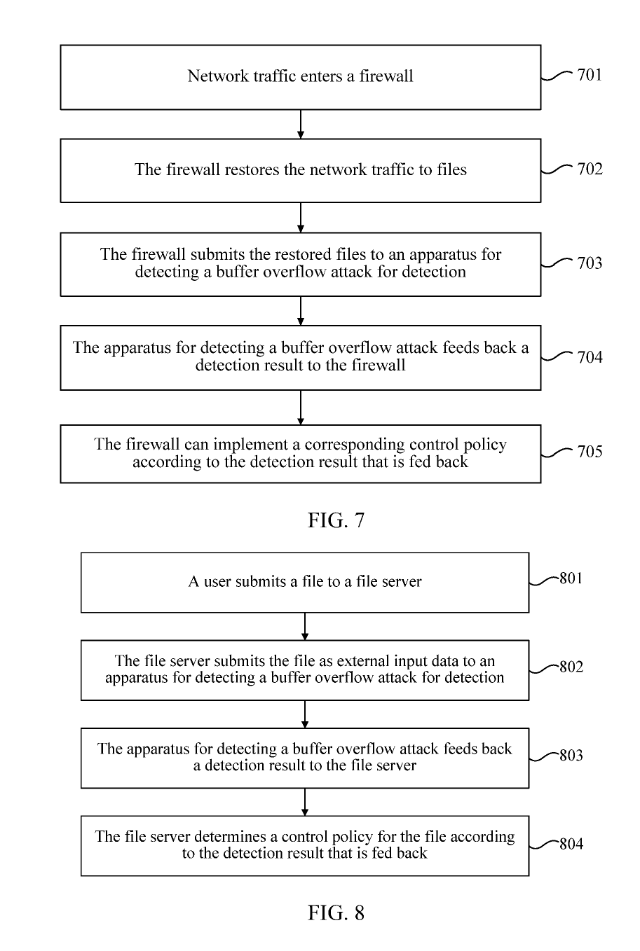

FIG. 7 is a flowchart diagram of a method for detecting a buffer overflow attack according to Embodiment 7 of the present disclosure. As shown in FIG. 7, in this embodiment of the present disclosure, an apparatus for detecting a buffer overflow attack may be used in combination with various security products. An example in which the apparatus is combined with a firewall is used, and the method for detecting a buffer overflow attack is performed using the apparatus for detecting a buffer overflow attack of the foregoing embodiment of the present disclosure, and may include the following steps.

Step 701: Network traffic enters a firewall.

Step 702: The firewall restores the network traffic to files, where these restored files may be used as external input data of a target process.

Step 703: The firewall submits the restored files to the apparatus for detecting a buffer overflow attack for detection, where if the target process is a WEBKIT, reference may be made to relevant description of step 601 to step 607.

Step 704: The apparatus for detecting a buffer overflow attack feeds back a detection result to the firewall.

Step 705: The firewall can implement a corresponding control policy according to the detection result that is fed back.

According to this embodiment, an apparatus for detecting a buffer overflow attack may be combined with a network security apparatus, attack-code detection is started when script decoding is performed on external input data, which facilitates detection of attack code from data obtained by decoding, and can improve a detection rate of the attack code.

### Embodiment 8

FIG. 8 is a flowchart diagram of a method for detecting a buffer overflow attack according to Embodiment 8 of the present disclosure. As shown in FIG. 8, in this embodiment of the present disclosure, an apparatus for detecting a buffer overflow attack may work in coordination with a file-related application server such as a file server or a mail server, to provide a SHELLCODE detection capability. An example in which the apparatus is combined with a file server is used, and the method for detecting a buffer overflow attack is performed using the apparatus for detecting a buffer overflow attack of the foregoing embodiment of the present disclosure, and may include the following steps.

Step 801: A user submits a file to a file server.

Step 802: The file server submits the file used as external input data to the apparatus for detecting a buffer overflow attack for detection, where if a target process is a WEBKIT, reference may be made to relevant description of step 601 to step 607.

Step 803: The apparatus for detecting a buffer overflow attack feeds back a detection result to the file server.

Step 804: The file server determines a control policy for the file according to the detection result that is fed back.

According to this embodiment, an apparatus for detecting a buffer overflow attack may be combined with a file server, attack-code detection is started when script decoding is performed on external input data, which facilitates detection of attack code from data obtained by decoding, and may improve a detection rate of the attack code.

### Embodiment 9

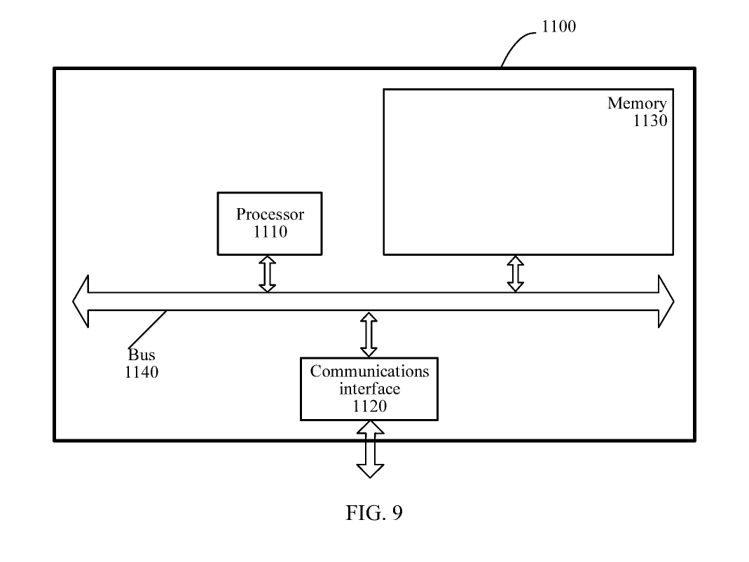

FIG. 9 is a schematic diagram of an apparatus for detecting a buffer overflow attack according to Embodiment 9 of the present disclosure. The apparatus 1100 for detecting a buffer overflow attack may be a host server, a personal computer (PC), or a portable computer or terminal that has a computation capability. Specific implementation of a computing node is not limited in a specific embodiment of the present disclosure.

The apparatus 1100 for detecting a buffer overflow attack includes a processor 1110, a communications interface 1120, a memory 1130 and a bus 1140. The processor 1110, the communications interface 1120, and the memory 1130 complete communication with each other using the bus 1140.

The communications interface 1120 is configured to communicate with a network device, where the network device includes, for example, a virtual machine management center, a shared storage, or the like.

The processor 1110 is configured to execute a program. The processor 1110 may be a central processing unit (CPU), an application specific integrated circuit (ASIC), or one or more integrated circuits configured to implement the embodiment of the present disclosure.

The memory 1130 is configured to save a file and code of the foregoing program. The memory 1130 may include a high-speed random-access memory (RAM) memory, and may also include a non-volatile memory, for example, at least one magnetic disk storage. The memory 1130 may also be a memory array. The memory 1130 may also be divided into blocks, and the blocks may be combined to form a virtual volume according to a rule.

In a possible implementation manner, the foregoing program may be program code that includes a computer operation instruction. The program may be used for controlling a target process to obtain external input data, and when the target process processes the external input data, if it is monitored that the target process performs decoding on the external input data, starting performing attack-code detection on data obtained by decoding, where the attack code is the code used for performing an overflow attack on a buffer.

In a possible implementation manner, before the target process obtains the external input data, the program is used for starting the target process, and controlling the target process to load a key data processing point hooked to the attack-code detection such that the target process, after loading the key data processing point, may start performing the attack-code detection when the key data processing point is detected, where the key data processing point is a memory allocation action and/or memory access action needed for performing script decoding on the external input data.

In a possible implementation manner, starting performing attack-code detection on data obtained by decoding includes performing, according to a rule for the attack code after decoding, matching on the data obtained by decoding, and determining whether the attack code exists in the data obtained by decoding.

In a possible implementation manner, after starting performing attack-code detection on data obtained by decoding, the program is used for outputting a detection log according to a result of the attack-code detection.

A person of ordinary skill in the art may be aware that, exemplary units and algorithm steps in the embodiments described in this specification may be implemented by electronic hardware or a combination of computer software and electronic hardware. Whether the functions are implemented by hardware or software depends on particular applications and design constraint conditions of the technical solutions. A person skilled in the art may select different methods to implement the described functions for a particular application, but it should not be considered that the implementation goes beyond the scope of the present disclosure.

If the functions are implemented in a form of computer software and sold or used as an independent product, it can be deemed to some extent that all or some of the technical solutions of the present disclosure, for example, the part contributing to the prior art, are implemented in a form of a computer software product. The computer software product is generally stored in a computer readable non-volatile storage medium and includes several instructions for instructing a computer device, which may be a personal computer, a server, or a network device, and the like, to perform all or some of the steps of the methods described in the embodiments of the present disclosure. The foregoing storage medium includes any readable storage medium that can store program code, such as a universal serial bus (USB) flash drive, a removable hard disk, a read-only memory (ROM), a RAM, a magnetic disk, or an optical disc.

After the program code in the readable storage medium is read by the CPU, the generated apparatus for detecting a buffer overflow attack may include a target process configured to obtain external input data, and an attack-code detection module configured to perform attack-code detection, where the attack code is the code used for performing an overflow attack on a buffer. The target process is further configured to invoke the attack-code detection module to start performing the attack-code detection on data obtained by decoding when processing the external input data, and if it is monitored that the target process performs decoding on the external input data.

In a possible implementation manner, the apparatus further includes a detection scheduling module configured to start the target process, and a hooking module configured to hook the attack-code detection module to a key data processing point of the target process, where the key data processing point is a memory allocation action and/or memory access action needed for performing script decoding on the external input data. The detection scheduling module is further configured to control the target process to load the hooking module. The target process, after loading the hooking module, is further configured to invoke the attack-code detection module to start performing the attack-code detection when the key data processing point is detected.

In a possible implementation manner, the target process is further configured to invoke the attack-code detection module to perform, according to a rule for the attack code after decoding, matching on the data obtained by decoding, and determine whether the attack code exists in the data obtained by decoding.

In a possible implementation manner, the attack-code detection module is further configured to output a detection log according to a result of the attack-code detection after starting performing the attack-code detection on the data obtained by decoding.

The foregoing descriptions are merely specific implementation manners of the present disclosure, but are not intended to limit the protection scope of the present disclosure. Any variation or replacement readily figured out by a person skilled in the art within the technical scope disclosed in the present disclosure shall fall within the protection scope of the present disclosure. Therefore, the protection scope of the present disclosure shall be subject to the protection scope of the claims.

What is claimed is:

1. An apparatus for detecting a buffer overflow attack, comprising:
a memory configured to store instructions; and
a processor coupled to the memory and configured to execute the instructions stored in the memory to:
obtain external input data for a target process;
determine that the target process decodes the external input data;
detect an attack code on the decoded external input data, wherein the attack code is a code used for performing an overflow attack on a buffer.

2. The apparatus according to claim 1, wherein when determining that the target process decodes the external input data, the processor is further configured to execute the instructions stored in the memory to:
detect a memory allocation action; and
perform script decoding on the external input data.

3. The apparatus according to claim 1, wherein when determining that the target process decodes the external input data, the processor is further configured to execute the instructions stored in the memory to:
detect a memory access action; and
perform script decoding on the external input data.

4. The apparatus according to claim 1, wherein the processor is further configured to execute the instructions stored in the memory to:
perform matching between the decoded external input data and a rule for the attack code after decoding; and
determine that the attack code exists in the decoded external input data when the decoded external input data matches with the rule.

5. The apparatus according to claim 2, wherein the processor is further configured to execute the instructions stored in the memory to:
perform matching between the decoded external input data and a rule for the attack code after decoding; and
determine that the attack code exists in the decoded external input data when the decoded external input data matches with the rule.

6. The apparatus according to claim 1, wherein the processor is further configured to execute the instructions stored in the memory to output a detection log recording as a result of the attack code detection.

7. The apparatus according to claim 2, wherein the processor is further configured to execute the instructions stored in the memory to output a detection log recording as a result of the attack code detection.

8. A non-transitory computer readable medium storing computer executable instructions that when executed in a computer, performs:
running an application program to generate a target process;
obtaining external input data for the target process;
determining that the target process decodes the external input data;
detecting an attack code on the decoded external input data, wherein the attack code is a code used for performing an overflow attack on a buffer.

9. The non-transitory computer readable medium according to claim 8, wherein determining that the target process decodes the external input data comprises:
detecting a memory allocation action; and
performing script decoding on the external input data.

10. The non-transitory computer readable medium according to claim 9, wherein before obtaining the external input data for the target process, the computer executable instructions further performs hooking the action of detecting the attack code on the decoded external input data to the memory allocation action for performing script decoding on the external input data.

11. The non-transitory computer readable medium according to claim 8, wherein determining that the target process decodes the external input data comprises:
detecting a memory access action; and
performing script decoding on the external input data.

12. The non-transitory computer readable medium according to claim 11, wherein before obtaining the external input data for the target process, the computer executable instructions further performs hooking the action of detecting the attack code on the decoded external input data to the memory access action for performing script decoding on the external input data.

13. The non-transitory computer readable medium according to claim 8, wherein detecting the attack code on the decoded external input data comprises:
performing matching between the decoded external input data and a rule for the attack code after decoding; and
determining that the attack code exists in the decoded external input data when the decoded external input data matches with the rule.

14. The non-transitory computer readable medium according to claim 8, wherein after detecting the attack code on the decoded external input data, the computer executable instructions further performs outputting a detection log recording as a result of the attack code detection.

15. A method implemented by a network device for detecting a buffer overflow attack, comprising:
obtaining external input data for a target process;
determining that the target process decodes the external input data;
detecting an attack code on the decoded external input data, wherein the attack code is a code used for performing an overflow attack on a buffer.

16. The method according to claim 15, wherein determining that the target process decodes the external input data comprises:
detecting a memory allocation action; and
performing script decoding on the external input data.

17. The method according to claim 15, wherein determining that the target process decodes the external input data comprises:
detecting a memory access action; and
performing script decoding on the external input data.

18. The method according to claim 15, wherein detecting the attack code on the decoded external input data comprises:
performing matching between the decoded external input data and a rule for the attack code after decoding; and
determining that the attack code exists in the decoded external input data when the decoded external input data matches with the rule.

19. The method according to claim 15, further comprising outputting a detection log recording as a result of the attack code detection.

20. The method according to claim 15, wherein the attack code is a shell code.
